(19) United States
(12) Patent Application Publication
(10) Pub. No.: US 2018/0063712 A1
(43) Pub. Date: Mar. 1, 2018

(54) INTERACTIVE BILLBOARD SYSTEM FOR AN ELEVATOR

(71) Applicant: Otis Elevator Company, Farmington, CT (US)

(72) Inventors: Erwann Odye, Beaulieu Sur Loire (FR); Franck J. Det, Gien (FR)

(21) Appl. No.: 15/555,302

(22) PCT Filed: Mar. 4, 2015
(86) PCT No.: PCT/IB2015/001019

§ 371 Date: Sep. 1, 2017

(51) Int. Cl. H04W 12/06; H04L 29/06; H04W 12/08

(52) U.S. Cl. CPC H04W 12/06; H04L 63/083; G06K 19/06037; H04W 12/08; H04L 63/107; H04L 63/0853

(57) ABSTRACT

An interactive billboard system includes a main control module configured to communicate with a smart device. The main control module has a location module to determine a location of image data transmitted by the smart device, an authentication module that authenticates a smart device based at least in part on authentication information transmitted by the smart device, and a content module that receives content information from the authenticated smart device and transmits the content information to a display positioned in an elevator car.

### FIELD OF THE INVENTION

The subject matter disclosed herein relates to interactive billboard systems, and in particular to an interactive billboard display.

### BACKGROUND

The interior of an elevator car can be a space to convey information to passengers. Passengers may post physical documents, but these documents may leave the interior cluttered or may not be removed over time. Additionally, a space to post physical documents allows any passenger of the elevator to post information, regardless of whether the passenger is allowed to post information. Therefore, it is necessary to dynamically and interactively regulate information posted to a billboard within an elevator.

### BRIEF DESCRIPTION OF THE INVENTION

In one aspect, an interactive billboard system comprises a main control module configured to communicate with a smart device, the main control module including a location module to determine a location of image data transmitted by the smart device; an authentication module that authenticates a smart device based at least in part on authentication information transmitted by the smart device, and a content module that receives content information from the authenticated smart device and transmits the content information to a display positioned in an elevator car.

In another aspect, a method of interactively posting content to an elevator billboard comprises determining a location of image data transmitted by a smart device, authenticating the smart device based at least in part on authentication information transmitted by the smart device, receiving content information from the authenticated smart device; and transmitting the content information to a display positioned in an elevator car.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is an illustration of an interactive billboard system in accordance with one embodiment of the invention.

FIG. 2 is an illustration of an authentication method for an interactive billboard system in accordance with one embodiment of the invention

### DETAILED DESCRIPTION OF THE INVENTION

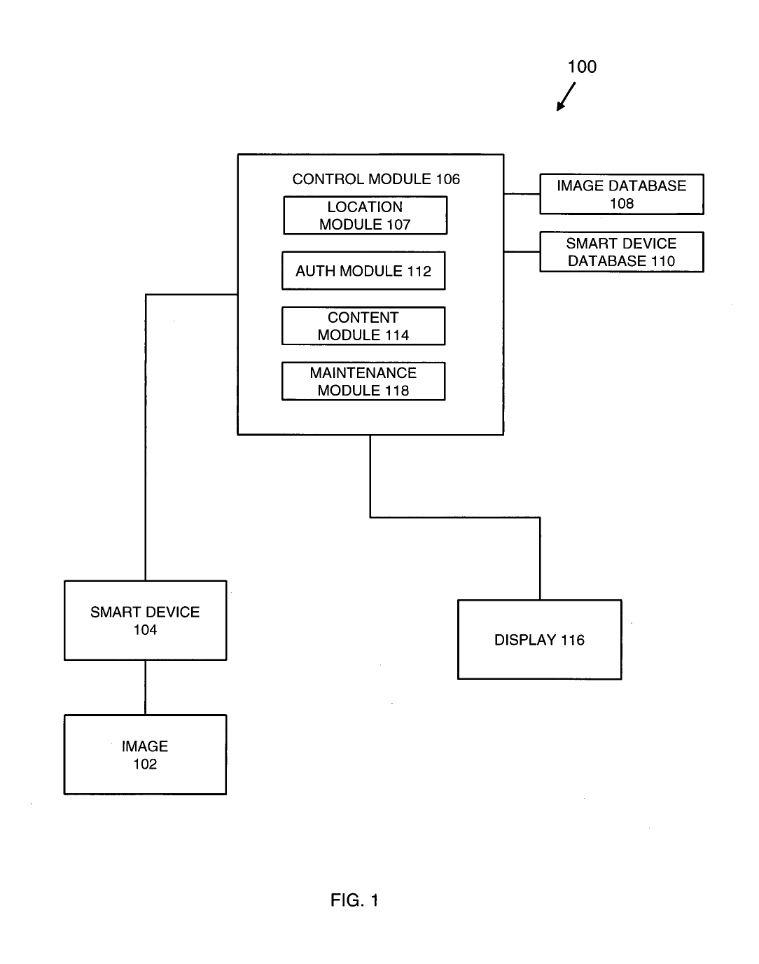

Referring now to FIG. 1, a block diagram illustrates an embodiment of an interactive billboard system 100 configured to locate and display information. The interactive billboard system 100 includes one or more identification (ID) images 102 accessed by a smart device 104. The interactive billboard system 100 further includes a main control module 106. The smart device 104 is configured to detect data, such as an image 102, and electrically communicate image data to the main control module 106. Based on the image data, the main control module 106 may perform various operations including, but not limited to, automatically authenticating the smart device 104, prompting the smart device 104 for login information, or prompting the smart device 104 for content information. Operation of the main control module 106 is discussed in greater detail below.

The image 102 is configured to indicate identification (ID) information to the main control module 106. The ID information includes, but is not limited to, the location of where the image is formed, the type of display paired with the images 102, and the number of displays present in the elevator car. The image 102 may include an optically machine-readable image capable of being attached to a surface and/or component. The optically machine-readable image records information related to the surface or component it is attached to. For example, the optically machine-readable image may be recorded with information to identify a particular elevator car.

The optically machine-readable image may then be placed on a wall of the elevator car, or may be formed on a component of the elevator car. The optically machine-readable image may be formed as a quick response (QR) code, a bar code, a bitmap image, or any other image capable of identification information and/or identifying a corresponding elevator car and/or area containing the component. In addition, the image 102 may be formed using standard printing technology, mechanical formation, laser formation, chemical etching, or other means. The image 102 may also include holographic image or three-dimensional images.

In the case of a QR code, for example, a plurality of black modules (square dots) may be arranged in a square grid on a white background image to form an image. The image indicates the information encoded by a QR code may be made up of various types of data including, but not limited to, numeric, alphanumeric, byte/binary, etc. The image 102 may be captured and/or processed by the smart device 104. For example, the image may be processed to provide a web address that the smart device can access to electrically communicate with main control module 106. The electrical communication between the smart device 104 and the main control module 106 may take place over a local area network, wide area network, the Internet, etc.

The main control module 106 may contain a location module 107 in communication with an image database 108 and a smart device database 110. The location module 107 may process the image signal received from the smart device 104 and compare the image signal to images stored in the image database 108. The images stored in the image database 108 may correspond to a specific location (i.e. elevator car). The location module 107 analyzes the image signal to determine the location of the transmission.

The smart device 104 may transmit an authentication token with the image signal. The location module 107 is configured to communicate with an authentication module 112 to analyze the authentication token. The authentication token may uniquely identify the smart device 104 transmitting the image signal. The authentication module 112 may access the smart device database 110 to compare the authentication token with authorized smart devices. The smart device database 110 may include a look-up table (LUT) storing smart device identification information, including registered smart devices. Registered smart devices are devices that identify users who may post to the display or billboard.

If the authentication module 112 does not receive an authentication token with the image signal transmitted by the smart device, the authentication module 112 may prompt the smart device 104 for manual authentication information. Manual authentication information may include but is not limited to a numerical code or a username/password combination entered in a web browser form on the smart device.

A content module 114 is in communication with the authentication module 112. The validation of the authentication token or manual authentication information from the smart device 104 enables the content module 114 to communicate with the smart device 104. The content module 114 may receive billboard content from the smart device 104 following authentication. A user of the smart device 104 may enter the content information on the smart device 104 or the user may select a file stored on the smart device 104, such as a picture or text file. The content module 114 receives the content information from the smart device 104 and transmits the content information to a display or billboard 116 positioned in the elevator car.

In addition, the content module 114 may access previously-posted content associated with a smart device 104 that has been authenticated. For example, a smart device 104 may have posted information during a previous display session. A user of the smart device 104 may modify the previously-posted content or remove the previously-posted content associated with the authenticated smart device 104. Allowing a user to remove or edit previously-posted content facilitates up-to-date content on the display or billboard for passengers of the elevator car.

The display or billboard 116 may be in wired or wireless communication with the content module of the main control module 116 and the content module 114. In one embodiment, the display is an electronic display, such as a liquid crystal display (LCD), however other types of electronic displays are contemplated.

A one-way mirror is overlaid in front of the electronic display in one embodiment, positioning the one-way mirror between the electronic display and the passenger compartment. The one-way mirror is a piece of glass that is partially reflective and partially transparent. The one-way mirror substantially prevents sight of the display when the display is not in operation (i.e. when the display is not producing light). When the display is in operation or producing light, the one-way mirror becomes more transparent, allowing passengers to see the display and any associated content. In addition to creating a more visually pleasing passenger compartment, the one-way mirror may also protect the display.

The main control module may further comprise a maintenance module 118. The maintenance module may access an updatable rule database 120. The updatable rule database 120 may include rules that dictate a length of time a message may appear on the display, or specific phrases that are not allowed to be displayed on the display or billboard 116. The content module 114 may communicate with the maintenance module 118 periodically, or the maintenance module 118 may be polled by the content module to verify content before transmission to the display. The polling and verification may prevent inappropriate messages and expired messages from appearing on the display.

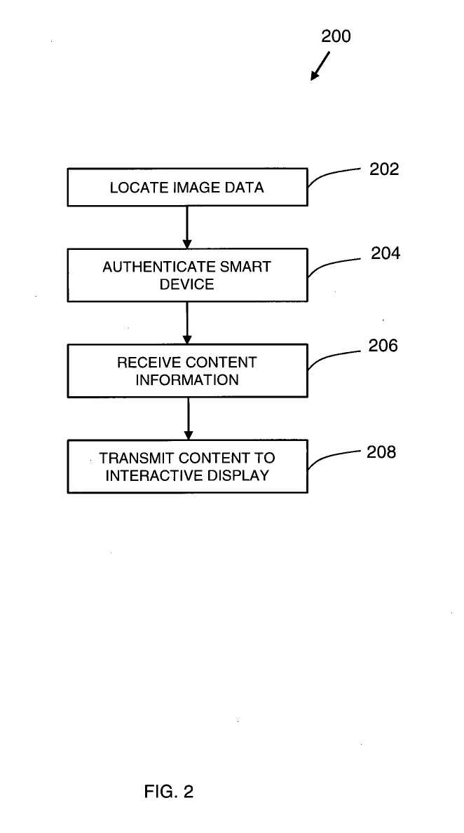

FIG. 2 illustrates a method 200 in accordance with the subject invention. At step 202, a location of image data transmitted by a smart device is determined. At step 204, the smart device is authenticated based at least in part on authentication information transmitted by the smart device. At step 206, content information is received from the authenticated smart device. At step 208, the content information is transmitted to a display positioned in an elevator car. As described above, the display can be an electronic display with a one-way mirror overlaid on the electronic display.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. An interactive billboard system comprising:
a main control module configured to communicate with a smart device, the main control module including:
a location module to determine a location of image data transmitted by the smart device;
an authentication module that authenticates a smart device based at least in part on authentication information transmitted by the smart device; and
a content module that receives content information from the authenticated smart device and transmits the content information to a display positioned in an elevator car.

2. The system of claim 1, wherein the authentication module accesses a smart device database that includes registered smart devices that transmit content information to the display.

3. The system of claim 1, wherein the authentication information includes an authentication token transmitted with image data, the image data transmitted by the smart device.

4. The system of claim 1, wherein the authentication information includes manual identification information received by the smart device in response to a prompt provided by the authentication module.

5. The system of claim 1, wherein the location module determines a location of image data by accessing an image database in response to receiving the image data, the image database including an identifier of the display positioned in the elevator car.

6. The system of claim 5, wherein the image data is associated with the display.

7. The system of claim 1, wherein the image data corresponds to a quick response (QR) code that identifies the display.

8. The system of claim 1, wherein the content information includes a picture transmitted from the smart device.

9. The system of claim 1, the main control module further comprises a maintenance module in communication with the content module, the maintenance module evaluates content information to determine a length of display time.

10. The system of claim 9, wherein the maintenance module accesses an updatable rule database to verify the content information.

11. The system of claim 1, wherein the display is an electronic display, wherein a one-way mirror is overlaid on the display.

12. A method of interactively posting content to an elevator billboard, the method comprising:
determining a location of image data transmitted by a smart device;
authenticating the smart device based at least in part on authentication information transmitted by the smart device;
receiving content information from the authenticated smart device; and
transmitting the content information to a display positioned in an elevator car.

13. The method of claim 12, further comprising evaluating the received content information to determine a length of display time.

14. The method of claim 12, wherein the determining a location of image data includes accessing an image database in response to receiving the image data, the image database including an identifier of the display positioned in the elevator car.

15. The method of claim 12, wherein the authentication information includes an authentication token transmitted with image data, the image data transmitted by the smart device.
